(19) United States
(12) Patent Application Publication
(10) Pub. No.: US 2006/0177128 A1
(43) Pub. Date: Aug. 10, 2006

(54) White balance with zone weighting

(76) Inventors: Karthik Raghupathy, Corvallis, OR (US); Dwight Poplin, Corvallis, OR (US)

Correspondence Address: AGILENT TECHNOLOGIES, INC.;INTELLECTUAL PROPERTY ADMINISTRATION, LEGAL DEPT., P.O. BOX 7599, M/S DL429, LOVELAND, CO, 80537-0599, US

(21) Appl. No.: 11/238,273

(22) Filed: Sep. 29, 2005

Related U.S. Application Data
(63) Continuation-in-part of application No. 11/054,095, filed on Feb. 8, 2005.

(51) Int. Cl. G06K 9/00; G06K 9/40

(52) U.S. Cl. 382/167; 382/274

(57) ABSTRACT

An image processing system includes a sensor, a processor, and a memory. The sensor is configured to capture data representative of a scene illuminated by an actual illuminant and the processor is configured to receive and process the captured data. The memory is configured to store chromaticity data associated with a plurality of plausible illuminants. The processor divides the captured data into a plurality of zones. The processor also calculates an average chromaticity for each zone and compares the calculated chromaticity for each zone with the chromaticity data of the plausible illuminants. The processor selects one of the plausible illuminants based upon the comparison.

### CROSS-REFERENCE TO RELATED APPLICATIONS

This Patent Application is a Continuation-in-Part of, and claims priority from U.S. patent application Ser. No. 11/054,095, filed Feb. 8, 2005, entitled, “SPECTRAL NORMALIZATION USING ILLUMINANT EXPOSURE ESTIMATION” having Attorney Docket No. 10040048-1, which is assigned to the same assignee as herein, and which are herein incorporated by reference.

### BACKGROUND

Under a large variety of scene illuminants, a human observer sees the same range of colors; a white piece of paper remains resolutely white independent of the color of light under which it is viewed. In contrast, color imaging systems (for example, digital cameras) are less color constant in that they will often infer the color of the scene illuminant incorrectly. Consequently, in order to accurately reproduce color in such imaging systems, adjustments or accommodations for this effect are typically made or used in processing images.

In some image processing, the color of the scene illumination is separately measured in order to produce more color constant images. In many imaging systems, however, it is not practical to have an illumination sensor and expect users to calibrate to this measured reference. In other image processing systems, the color of the scene illumination is estimated from the image data. Often, this may be done using a “gray world assumption.” With some of these estimation methods, however, the color consistency is still less than acceptable for some images.

For these and other reasons, a need exists for the present invention.

### SUMMARY

One aspect of the present invention provides an image processing system having a sensor, a processor, and a memory. The sensor is configured to capture data representative of a scene illuminated by an actual illuminant and the processor is configured to receive and process the captured data. The memory is configured to store chromaticity data associated with a plurality of plausible illuminants. The processor divides the captured data into a plurality of zones. The processor also calculates an average chromaticity for each zone and compares the calculated chromaticity for each zone with the chromaticity data of the plausible illuminants. The processor selects one of the plausible illuminants based upon the comparison.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. Like reference numerals designate corresponding similar parts.

FIG. 1 illustrates an image processing system in accordance with one embodiment of the present invention.

FIG. 2 illustrates a plot of chromaticity for a variety of plausible illuminants.

FIG. 3 illustrates a flow diagram for a process in an image processing system in accordance with one embodiment of the present invention.

FIG. 4 illustrates a plot of chromaticity for a variety of plausible illuminants and for a variety of image zones in accordance with one embodiment of the present invention.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

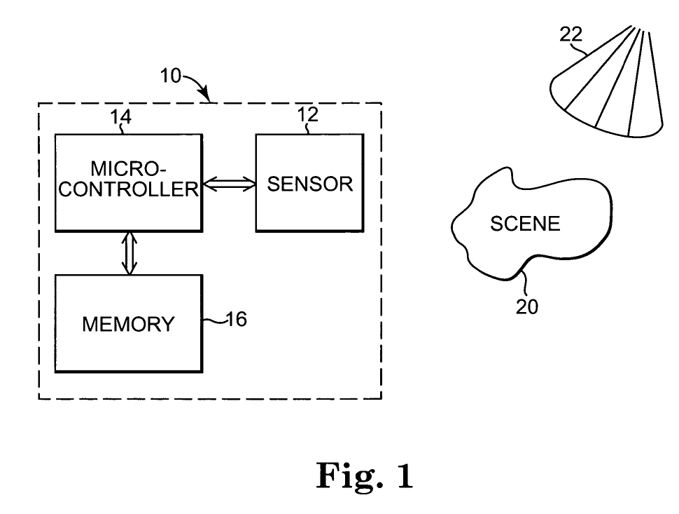

FIG. 1 is a block diagram illustrating image processing system 10 in accordance with one embodiment of the present invention. Image processing system 10 includes sensor 12, microcontroller 14 and memory 16. In operation, sensor 12 is configured to capture data representative of an image or scene 20. The captured image or scene data is typically in digital form and is then processed by microcontroller 14 in association with memory 16.

In one embodiment, scene 20 is illuminated with illuminant 22. Illuminate 22 can be a variety of light sources consistent with the present invention. For example, illuminant 22 can be the sun, a florescent light, a tungsten light, or any of a multitude of light sources. Typically, the particular type of illuminant 22 associated with any given captured scene 20 is unknown to image processing system 10. In one embodiment, however, image processing system 10 is configured with data associated with a plurality of known “plausible illuminants.” For example, there are a limited amount of sunlight conditions that are likely to be used as illuminant 22 for a scene 20, a limited amount of tungsten lights that are likely to be used as illuminant 22 for a scene 20, a limited amount of fluorescent lights that are likely to be used as illuminant 22 for a scene 20, and so on. These plausible illuminants, and certain associated scaling data more fully explained below, are stored in memory 16 and used by image processing system 10 in accordance with embodiments of the present invention.

In one embodiment, 15 different plausible illuminants are selected for image processing system 10, based on those types of illuminants that are likely to be used as illuminant 22 for a scene 20. Obviously, this is not all the possible illuminants that could be used, but in many cases, these capture most of the most-likely illuminants. In other embodiments a greater or lesser number of plausible illuminants are used.

For each of the plausible illuminants, a “gray world assumption” is made such that an average color point for each of the plausible illuminants is calculated and stored in memory 16. Then, a calculation of an average color point for any particular captured scene can be made and compared against the average color points for each of the plausible illuminants. In this way, one of the plausible illuminants can be selected as illuminant 22 for scene 20 based upon which of the plausible illuminants has an average color point that is closest to the calculated average color point for a particular captured scene.

For the captured data representing an image or scene, there are a set number of pixels. For a color image, each pixel in the image will have a certain amount of red (R), green (G) and blue (B). A gray world assumption provides that, given an image with sufficient amount of color variations, the average value of the R, G, and B components of the image should average out to a common gray value. Often this assumption is valid, since in any given real world scene, it is often the case that there are lots of different color variations. Since the variations in color are random and independent, the average color point should tend to converge to the mean value, which is gray.

As such, color balancing algorithms make use of this assumption by forcing images to have a uniform average gray value for R, G, and B color components. For example, if an image illuminated under yellow lighting is captured, the captured output image will have a yellow cast over the entire image. The effect of this yellow cast disturbs the gray world assumption of the original image. By enforcing the gray world assumption on captured image, the yellow cast may be removed to re-acquire the colors of our original scene. Once an overall gray value for the image is calculated, each color component is then scaled according to the amount of its deviation from this gray value. Scaling data for each of the plausible illuminants can be stored in memory 16.

In one embodiment, determining which of the plausible illuminants should be used for an acquired image involves pre-calculating “white points” for each of the plausible illuminants. In one case, this is done by first determining the amount of R, G, and B components for each of the pixels in an image. Then, the sum of all the R components, the sum of all the G components, and the sum of all the B components is calculated, and then each is divided by the number of pixels to determine the mean for each color. Next, the ratio of the R mean over the G mean is calculated, as is the ratio of the B mean over the G mean. These two values define a point for the R over G components in two-dimensional chromaticity space. This point is the white point.

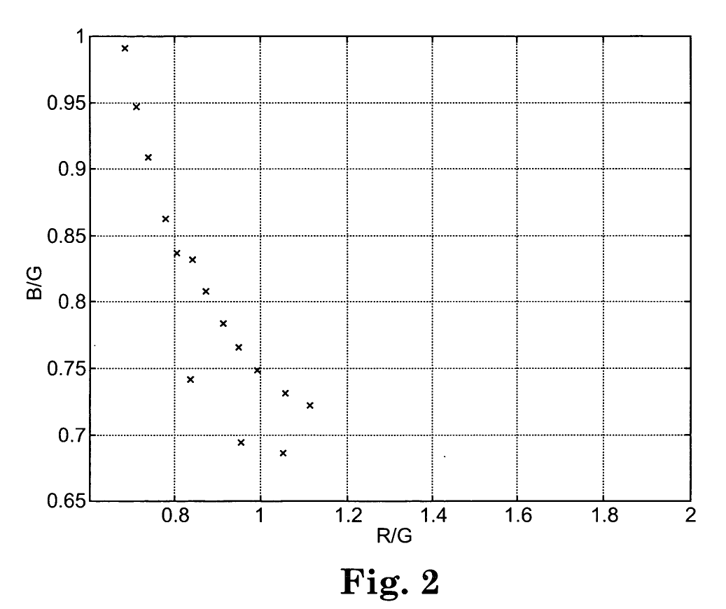

FIG. 2 illustrates a white point calculation for 15 different plausible illuminants. In the illustration, the total amount of B components to an image is divided by the total amount of G components to define the x-coordinate. The total amount of R components to an image is divided by the total amount of G components to define the y-coordinate. The result is the white point of each of the plausible illuminants, which are each represented by an “X” in the figure. Since each plausible illuminant produces varying color constancy in digital images, the calculated white point will vary among plausible illuminants. The calculated white point for each of the plausible illuminants is stored within memory 16.

In this way, once the white point of the captured data representing an image or scene is calculated, it is compared to the white point of each of the plausible illuminants stored within memory 16. The plausible illuminant with a white point closest to the white point calculated for the captured image is then selected as illuminant 22. Once the plausible illuminant is selected, the difference between its white point and the white point calculated for the captured image can be used to apply suitable white balance and color correction for the captured image.

Calculating a single white point for an entire image, however, can produce uneven results in certain situations. For example, if scene 20 has a large amount of a single color, the gray world assumption will not necessarily be an accurate assumption. Thus, in the case where an image is mostly a large bright turquoise ocean, it is unlikely that the average of the scene is gray. In this way, one embodiment of the invention adjusts the calculation of the white point of the acquired image accordingly.

In one embodiment, the acquired image is divided into zones. The average R, G, and B components of each zone are then calculated. For each zone, a white point can be computed (in one case, using R/G and B/G coordinates). As such, color dominance in any particular zone within the captured image causes that zone's chromaticity to be far away from any of the plausible illuminant white points. In this way, such zones are neglected when computing an overall white point for the captured image. Only zones that result in a chromaticity that is near a white point of a plausible illuminant are used to estimate the overall image white point. This overall image white point is then used to select illuminant 22 from the plausible illuminants in order to correspondingly make color adjustments to the acquired image.

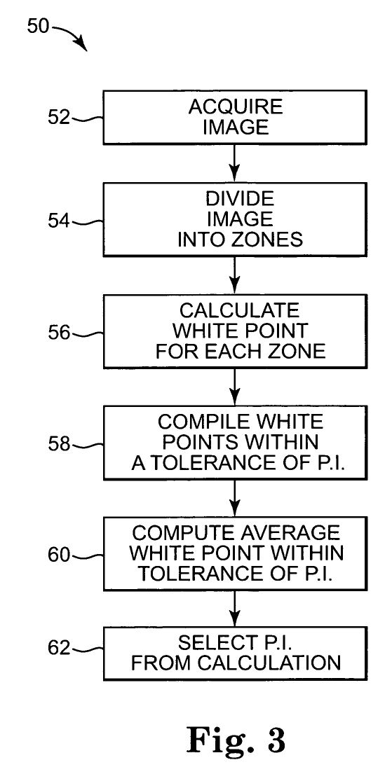

FIG. 3 is a flow chart illustrating a process 50 for an image processing system in accordance with one embodiment of the present invention. In a first step 52, a sensor within an image processing system is configured to capture data representative of an image or scene. The captured image or scene data is then divided into zones at step 54. In one embodiment, a captured image has over one million pixels, for example 1024×1280 pixels. Each pixel in the image has an R, G and B component. In one case, that captured image is then divided into 64 separate zones, such there is an 8×8 grid structure of zones, with each zone having 128×160 pixels.

At step 56, a white point is calculated for each of the zones. In one case, this white point is computed by calculating R/G and B/G coordinates for each zone. Once a white point is calculated for each of the zones for an acquired image, each of these calculated white points are compared to the stored white points for a variety of plausible illuminants. Any of the calculated white points from the zones that are not within a tolerance range of the white points for the variety of plausible illuminants are discarded (discarded white points).

Any of the calculated white points from the zones that are within the tolerance range of the white points for the variety of plausible illuminants are then compiled at step 58 (compiled white points). In this way, the compiled white points are those that most-closely approximate the white points of the variety of plausible illuminants. An average of the compiled white points is computed at step 60.

At step 62, this average white point, based on the compiled white points, is taken and compared against each of the stored white points for each of the variety of plausible illuminants. The one to which the average white point is closest is then selected as the plausible illumination for the system. In this way, stored data that is associated with the selected plausible illumination is used to scale each color component of the captured image according to the amount of deviation between the white points.

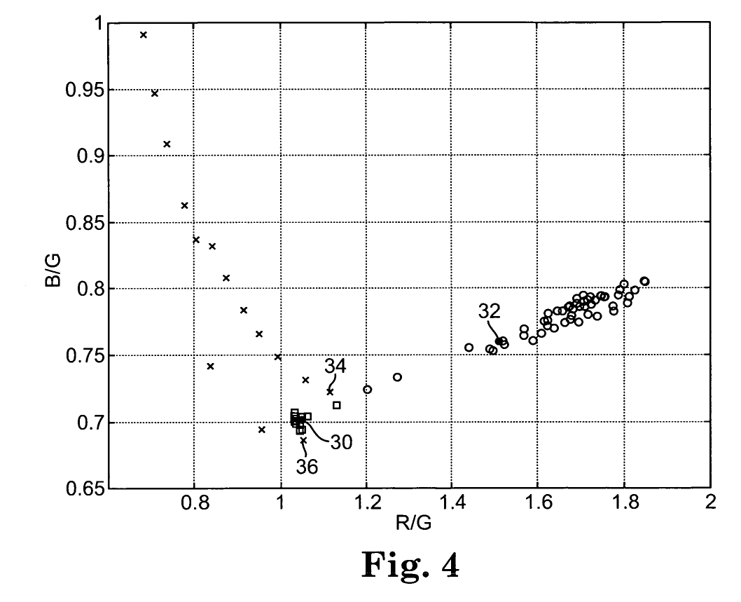

FIG. 4 illustrates white point calculations for 15 different plausible illuminants and for each of 64 zones of a captured image. The white points for the plausible illuminants are illustrated with an “X”, and the white points for each of 64 zones of a captured image are illustrated with open circles and open squares.

In one embodiment, a tolerance range is established within which white points for the zones of the captured image must fall in order to be included in the calculation of an overall average. In one embodiment, the tolerance range is within 10% of each of the coordinates of the white point. In other embodiments, the tolerance range is smaller and in others it is larger. In the illustration, all of the white points for the 64 zones that fall outside the tolerance range of the white points for the plausible illuminants are illustrated as open circles (discarded white points). All of the white points for the 64 zones that fall within the tolerance range of the white points for the plausible illuminants are illustrated as open squares (compiled white points).

The average of all the white points for the 64 zones (those illustrated with both open circles and with open squares in the figure) is represented by the solid circle 32 in FIG. 4. In one embodiment of the invention, however, all of the discarded white points for the 64 zones (that is, those that fall outside the tolerance range of the white points for the plausible illuminants and are illustrated with open circles in the figure) are not used in computing the average white point. Instead, only the compiled white points for the 64 zones (that is, those that are within the tolerance range of the white points for the plausible illuminants and are illustrated with open squares in the figure) are kept and averaged. This average of all the compiled white points is represented by the solid circle 30 in FIG. 4. In this way, by eliminating those white points for the 64 zones that fall outside the tolerance range, the average white point 30 is closer to the white points for the plausible illuminants than is the overall average white point 32. This can provide a more accurate detection of the plausible illuminant.

In the illustration, less than ⅓ of the white points calculated for the 64 zones fall within the tolerance range of the white points for the plausible illuminants. This will be the case for images that have a large portion of a dominant color, for example, a scene made up mostly turquoise water or made up of mostly blue sky with only a relatively small amount of dark color. Such captured images will result, as illustrated in FIG. 4, in a large majority of white points calculated for the 64 zones falling outside the tolerance range of the white points for the plausible illuminants.

In the illustration of FIG. 4, eliminating some of the white points (those outside the tolerance range) calculated for the 64 zones, changes the average white point from white point 32 to white point 30. In the case where no adjustment is made, using white point 32 results in selecting the plausible illuminant represented by the white point labeled 34 (since white point 34 is the closest plausible illuminant white point to the calculated average white point 32). In the case where adjustment is made, however, using white point 30 results in selecting the plausible illuminant represented by the white point labeled 36 (since white point 36 is the closest plausible illuminant white point to the calculated average white point 30). In this way, by selecting the plausible illuminant using this improved estimate of the white point of the image, the selected plausible illuminant is more likely to be the actual illuminant for the captured scene. As such, when the colors of the scene are scaled using the data associated with the selected plausible illuminant, a good representation of the actual scene colors is achieved.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. An image processing system comprising:
a sensor configured to capture data representative of a scene illuminated by an actual illuminant;
a processor configured to receive and process the captured data; and
a memory configured to store chromaticity data associated with a plurality of plausible illuminants;
wherein the processor divides the captured data into a plurality of zones, calculates a chromaticity for each zone, compares the chromaticity for each zone with the chromaticity data of the plausible illuminants, and selects one of the plausible illuminants as a representative of the actual illuminant based upon the comparison.

2. The image processing system of claim 1, wherein the color of the captured data is adjusted based upon the chromaticity data associated with the selected plausible illuminant.

3. The image processing system of claim 1, wherein the processor establishes a tolerance range, averages the chromaticity for each zone having a chromaticity within the tolerance range, selects the plausible illuminant that has a chromaticity closest to the average chromaticity.

4. The image processing system of claim 3, wherein the captured data representative of a scene includes pixel information having red, green and blue components, and wherein chromaticity for each zone is calculated by calculated the average red, green and blue components in each zone.

5. The image processing system of claim 4, wherein the chromaticity data associated with a plurality of plausible illuminants includes a pre-calculated white point for each of the plausible illuminants, and wherein calculating the chromaticity for each zone includes calculating a white point for each zone.

6. The image processing system of claim 5, wherein each white point for each zone that is outside the tolerance range is eliminated, wherein each white point for each zone that is inside the tolerance range is used for an average white point, and wherein the plausible illuminant with a white point closest to the average white point is selected.

7. The image processing system of claim 5, wherein the white points are each calculated by calculating coordinates having an average red component divided by an average green component and an average blue component divided by an average green component.

8. The image processing system of claim 7, wherein the tolerance range within 10 percent of each of the coordinates calculated for the white point.

9. The image processing system of claim 1, wherein the captured image data is divided into at least 64 zones.

10. A method for processing image data comprising:
capturing data representative of a scene illuminated by an actual illuminant;
dividing the captured data into a plurality of zones;
calculating a chromaticity for each zone;
comparing the calculated chromaticity of each zone with a chromaticity of each of a plurality of plausible illuminants; and
selecting one of the plausible illuminants as a representative of the actual illuminant based upon the comparisons.

11. The method of claim 10 further including color adjusting the captured data based upon the chromaticity data associated with the selected plausible illuminant.

12. The method of claim 10 further comprising averaging together the chromaticity of each of the zones that have a chromaticity within a tolerance range, and further comprising selecting the plausible illuminant having a chromaticity closest to the calculated average chromaticity.

13. The method of claim 12, wherein calculating chromaticity for each zone includes calculating an average red, green and blue component for each zone of the captured data.

14. The method of claim 13, wherein calculating chromaticity for each zone includes calculating a white point for each zone and wherein calculating chromaticity data associated with a plurality of plausible illuminants includes calculating a white point for each of the plausible illuminants.

15. The method of claim 14, wherein calculating white points includes calculating coordinates having a average red component divided by an average green component and an average blue component divided by an average green component.

16. An image processing system comprising:
means for capturing and processing data representative of a scene illuminated by an actual illuminant;
means for storing chromaticity data associated with a plurality of plausible illuminants;
means for calculating a chromaticity for at least one zone of the representative data;
means for comparing the chromaticity of the at least one zone with the chromaticity data of the plausible illuminants; and
means for selecting one of the plausible illuminants as a representative of the actual illuminant based upon the comparison.

17. The image processing system of claim 16 further comprising means for calculating a chromaticity for a plurality of zones of the representative data, means for comparing the chromaticity of each of the zone with the chromaticity data of the plausible illuminants, and for selecting one of the plausible illuminants as a representative of the actual illuminant based upon each of the comparisons.

18. The image processing system of claim 16, wherein chromaticity is calculated for 64 zones of the representative data.

19. The image processing system of claim 18, wherein the processor establishes a tolerance range, averages the chromaticity for each zone having a chromaticity within the tolerance range, selects the plausible illuminant that has a chromaticity closest to the average chromaticity.

20. The image processing system of claim 19, wherein chromaticity is calculated by calculating a white point.
